(19) United States
(12) Patent Application Publication
(10) Pub. No.: US 2018/0188560 A1
(43) Pub. Date: Jul. 5, 2018

(54) Display Screen and Method for Repairing Bright Bot of Display Screen

(71) Applicants: BOE TECHNOLOGY GROUP CO., LTD., Beijing (CN); Hefei Xinsheng Optoelectronics Technology Co., Ltd., Hefei, Anhui (CN)

(72) Inventors: Liping LIU, Beijing (CN); Chunlei DONG, Beijing (CN)

(21) Appl. No.: 15/552,649

(22) PCT Filed: Feb. 21, 2017
(86) PCT No.: PCT/CN2017/074194

§ 371 Date: Aug. 22, 2017

(30) Foreign Application Priority Data
May 31, 2016 (CN) 201610375704.6

(51) Int. Cl. G02F 1/13; G02F 1/1335

(52) U.S. Cl. CPC G02F 1/1309; G02F 2201/508; G02F 1/133512

(57) ABSTRACT

The present application provides a display screen and a method for repairing a bright dot of the display screen, the method comprises steps of: selecting a display screen having a bright dot sub-pixel, the display screen comprises a first substrate and a second substrate which are aligned and combined into a cell; and providing a shielding layer in a region, corresponding to a position of the bright dot sub-pixel, outside at least one of the first substrate and the second substrate. With the display screen and the method for repairing the bright dot of the display screen provided by the present application, the bright dot will not reappear, thus a stability of repairing is improved, thereby a reliability level of the display screen is improved.

### TECHNICAL FIELD

The present application relates to a field of display technology, and particularly, to a display screen and a method for repairing a bright dot of the display screen.

### BACKGROUND

It is a common problem that a bright dot is generated during manufacturing a thin film transistor liquid crystal display screen (TFT-LCD). The bright dot is represented at a sub-pixel always being on when the display screen is powered on, and the sub-pixel can be described as a bright dot sub-pixel. A main reason for the bright dot is that a thin film transistor (TFT) of a display region is invalid, and another reason for the bright dot is that there is a foreign matter in a liquid crystal cell so that liquid crystal molecules of the liquid crystal cell cannot normally deflect and present themselves as the bright dot.

For repairing the display screen having the bright dot, a common method of prior art is to repair the bright dot to a dark dot by a laser, a success rate of repairing is affected by a stability of energy of the laser and practical experiences, but the bright dot may reappear due to vibration and transport during subsequent procedures, resulting in that a reliability level of the display screen is affected.

Thus, currently, there is an urgent need for a method having a good stability for repairing the bright dot of the display screen.

### SUMMARY

In view of at least one problem of prior art, the present application provides a display screen and a method for repairing a bright dot of the display screen, which can ensure that the bright dot will not reappear, thus can improve a stability of repairing, thereby can improve the reliability level of the display screen.

In an aspect, the present application provides a method for repairing a bright dot of a display screen, the method comprises steps of: selecting a display screen having a bright dot sub-pixel, the display screen comprises a first substrate and a second substrate which are aligned and combined into a cell; and providing a shielding layer in a region, corresponding to a position of the bright dot sub-pixel, outside at least one of the first substrate and the second substrate.

Specifically, the step of providing the shielding layer in the region, corresponding to the position of the bright dot sub-pixel, outside at least one of the first substrate and the second substrate comprises: forming the shielding layer in the region, corresponding to the position of the bright dot sub-pixel, outside at least one of the first substrate and the second substrate by spraying a light shielding material.

Optionally, the light shielding material includes a material of black ink.

Optionally, the step of providing the shielding layer in the region, corresponding to the position of the bright dot sub-pixel, outside at least one of the first substrate and the second substrate comprises: providing the shielding layer in the region, corresponding to the position of the bright dot sub-pixel, on an outer side of at least one of the first substrate and the second substrate.

Optionally, the method for repairing the bright dot of the display screen further comprises a step of providing a first polarizer on an outer side of the first substrate and providing a second polarizer on an outer side of the second substrate, and the step of providing the shielding layer in the region, corresponding to the position of the bright dot sub-pixel, outside at least one of the first substrate and the second substrate comprises: providing the shielding layer in the region, corresponding to the position of the bright dot sub-pixel, at the outer side of at least one of the first polarizer and the second polarizer.

In another aspect, the present application further provides a display screen comprising a first substrate and a second substrate which are aligned and combined into a cell, wherein a shielding layer is provided in a region, corresponding to a position of a bright dot sub-pixel, outside at least one of the first substrate and the second substrate.

Optionally, the shielding layer is provided in the region, corresponding to the position of the bright dot sub-pixel, on an outer side of at least one of the first substrate and the second substrate.

Optionally, a first polarizer is provided on an outer side of the first substrate, a second polarizer is provided on an outer side of the second substrate, and the shielding layer is provided in a region, corresponding to the position of the bright dot sub-pixel, on an outer side of at least one of the first polarizer and the second polarizer.

Optionally, the shielding layer comprises a material of black ink.

Technical solutions provided by the present application have following beneficial effects.

In the display screen and the method for repairing the bright dot of the display screen provided by the present application, the shielding layer is provided in the region, corresponding to the position of the bright dot, outside at least one of the first substrate and the second substrate, in order to block light from the display screen at the position of the bright dot, compared with a method for repairing a bright dot by laser in prior art, due to a high stability of the shielding layer, the bright dot will not reappear, thus the stability of repairing is improved, thereby the reliability level of the display screen is improved.

### BRIEF DESCRIPTION OF THE DRAWINGS

FIG. 1 shows a flowchart of a method for repairing a bright dot of a display screen in accordance with an embodiment of the present application;

FIG. 2 shows a structural diagram of a display screen having an unrepaired bright dot;

FIG. 3 shows a structural diagram of a repaired display screen obtained by repairing the display screen of FIG. 2 in accordance with an embodiment of the present application;

FIG. 4 shows a structural diagram of another repaired display screen obtained by repairing the display screen of FIG. 2 in accordance with an embodiment of the present application.

### DETAILED DESCRIPTION OF THE EMBODIMENTS

In order to make a person skilled in the art understand technical solutions of the present application better, the display screen and the method for repairing a bright dot of the display screen provided by the present application will be described in detail below in conjunction with accompanying drawings.

### First Embodiment

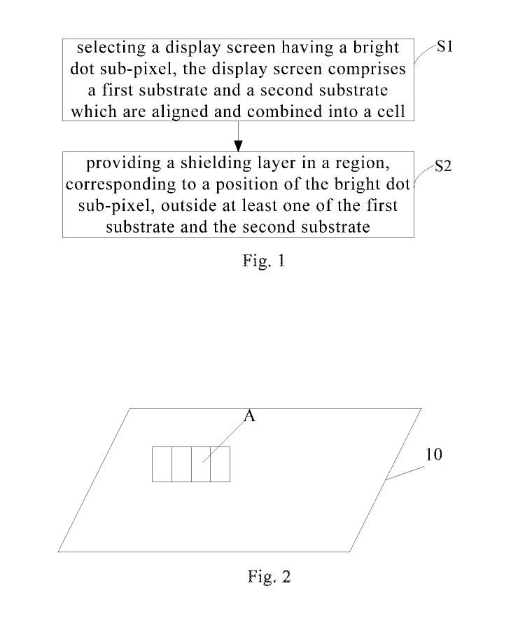

FIG. 1 shows a flowchart of a method for repairing a bright dot of a display screen in accordance with an embodiment of the present application.

Referring to FIGS. 1-3, the method for repairing the bright dot of the display screen in accordance with the present embodiment comprises steps of S1 and S2.

S1, selecting a display screen having a bright dot sub-pixel, the display screen comprises a first substrate and a second substrate which are aligned and combined into a cell.

In the present embodiment, the first substrate may be (but not limited to) an array substrate, and the second substrate may be (but not limited to) a color filter substrate.

The step S1 specifically comprises: during detecting, collecting the display screen having the bright dot and recording a position of the bright dot sub-pixel on the display screen.

S2, providing a shielding layer in a region, corresponding to the bright dot sub-pixel, outside at least one of the first substrate and the second substrate, for example, the shielding layer covers an orthographic projection of the bright dot sub-pixel on at least one of the first substrate and the second substrate, so that light through the bright dot sub-pixel cannot emit from the display screen to enter into eyes of human, or the light cannot emit from the display screen via the bright dot sub-pixel.

Specifically, the step S2 comprises: according to the position of the bright dot sub-pixel recorded in the step S1, providing the shielding layer in the region, corresponding to the position, outside at least one of the first substrate and the second substrate.

Optionally, the step S2 comprises: forming the shielding layer in the region, corresponding to the position of the bright dot sub-pixel, outside at least one of the first substrate and the second substrate by spraying a light shielding material. It should be understood that, it is relatively simple to forming the shield layer by spraying the light shielding material.

Further optionally, the light shielding material includes a material of black ink. Specifically, by spraying black ink in the region, corresponding to the position of the bright dot sub-pixel, outside at least one of the first substrate and the second substrate, the shielding layer is formed to block light from the display screen.

In addition, the step S2 may include: providing the shielding layer in the region, corresponding to the position of the bright dot sub-pixel, on an outer side of at least one of the first substrate and the second substrate. For example, the shielding layer is provided in the region, corresponding to the position of the bright dot sub-pixel, on the outer side of at least one of the array substrate and the color filter substrate.

Certainly, in practical applications, the method for repairing the bright dot of the display screen may further comprise steps of: providing a first polarizer on an outer side of the first substrate (i.e., a surface of the first substrate distal to the second substrate), and providing a second polarizer on an outer side of the second substrate (i.e., a surface of second substrate distal to the first substrate).

In this case, the step S2 includes: providing the shielding layer in the region, corresponding to the position of the bright dot sub-pixel, on an outer side of at least one of the first polarizer and the second polarizer.

As above, in the method for repairing the bright dot of the display screen in accordance with the present embodiment, the shielding layer is provided in the region, corresponding to the position of the bright dot, outside at least one of the first substrate and the second substrate, in order to block light from the display screen at the position of the bright dot, compared with a method for repairing a bright dot by laser in prior art, due to a high stability of the shielding layer, the bright dot will not reappear, thus the stability of repairing is improved, thereby the reliability level of the display screen is improved.

### Second Embodiment

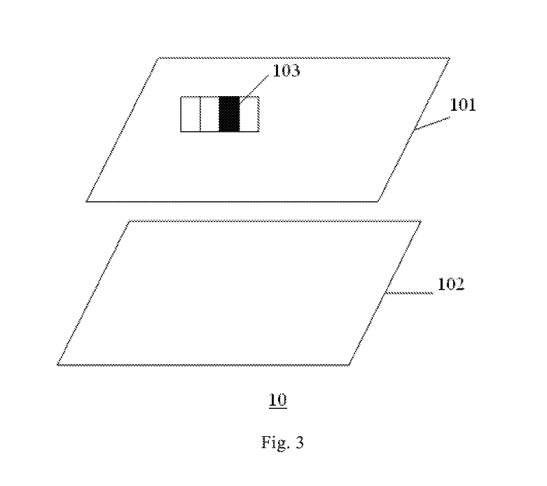

FIG. 2 shows a structural diagram of a display screen having an unrepaired bright dot, and FIG. 3 shows a structural diagram of a repaired display screen obtained by repairing the display screen of FIG. 2 in accordance with the present embodiment.

Referring to FIGS. 2 and 3, the display screen 10 of the present embodiment comprises a fist substrate 101 (may be, but not limited to, an array substrate) and a second substrate 102 (may be, but not limited to, a color filter substrate) which are aligned and combined into a cell. As shown in FIG. 2, the display screen 10 has a bright dot sub-pixel A. As shown in FIG. 3, in the present embodiment, a shielding layer 103 is provided in a region, corresponding to a position of the bright dot sub-pixel A, outside at least one of the first substrate 101 and the second substrate 102.

Optionally, the shielding layer 103 is formed by a spraying method.

Further optionally, the shielding layer 103 includes a material of black ink.

Optionally, the shielding layer 103 is provided in the region, corresponding to the position of the bright dot sub-pixel A, on the outer side of at least one of the first substrate 101 and the second substrate 102, as shown in FIG. 3.

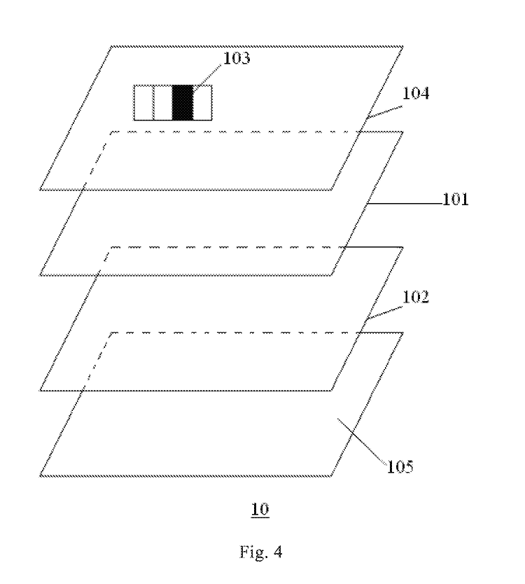

FIG. 4 shows a structural diagram of another repaired display screen obtained by repairing the display screen of FIG. 2 in accordance with the present embodiment.

Referring to FIG. 4, a first polarizer 104 is provided on the outer side of the first substrate 101 (i.e., the surface of the first substrate 101 distal to the second substrate 102), and a second polarizer 105 is provided on the outer side of the second substrate 102 (i.e., the surface of the second substrate 102 distal to the first substrate 101), and in this case, the shielding layer 103 may be provided in the region, corresponding to the position of the bright dot sub-pixel A, on the outer side of at least of the first polarizer 104 and the second polarizer 105.

It should be understood that, the above embodiments are merely exemplary embodiments for explaining principle of the present application, but the present application is not limited thereto. Various modifications and improvements may be made by those ordinary skilled in the art within the spirit and essence of the present application, these modifications and improvements fall into the protection scope of the present application.

1. A method for repairing a bright dot of a display screen, comprising steps of:
selecting a display screen having a bright dot sub-pixel, the display screen comprises a first substrate and a second substrate which are aligned and combined into a cell; and
providing a shielding layer in a region, corresponding to a position of the bright dot sub-pixel, outside at least one of the first substrate and the second substrate.

2. The method of claim 1, wherein, the step of providing the shielding layer in the region, corresponding to the position of the bright dot sub-pixel, outside at least one of the first substrate and the second substrate comprises:
forming the shielding layer in the region, corresponding to the position of the bright dot sub-pixel, outside at least one of the first substrate and the second substrate by spraying a light shielding material.

3. The method of claim 2, wherein, the light shielding material includes a material of black ink.

4. The method of claim 1, wherein, the step of providing the shielding layer in the region, corresponding to the position of the bright dot sub-pixel, outside at least one of the first substrate and the second substrate comprises:
providing the shielding layer in the region, corresponding to the position of the bright dot sub-pixel, on an outer side of at least one of the first substrate and the second substrate.

5. The method of claim 1, further comprising a step of providing a first polarizer on an outer side of the first substrate and providing a second polarizer on an outer side of the second substrate,
the step of providing the shielding layer in the region, corresponding to the position of the bright dot sub-pixel, outside at least one of the first substrate and the second substrate comprises:
providing the shielding layer in the region, corresponding to the position of the bright dot sub-pixel, at the outer side of at least one of the first polarizer and the second polarizer.

6. A display screen, comprising a first substrate and a second substrate which are aligned and combined into a cell, wherein a shielding layer is provided in a region, corresponding to a position of a bright dot sub-pixel, outside at least one of the first substrate and the second substrate.

7. The display screen of claim 6, wherein, the shielding layer is provided in the region, corresponding to the position of the bright dot sub-pixel, on an outer side of at least one of the first substrate and the second substrate.

8. The display screen of claim 6, wherein, a first polarizer is provided on an outer side of the first substrate, a second polarizer is provided on an outer side of the second substrate, and
the shielding layer is provided in a region, corresponding to the position of the bright dot sub-pixel, on an outer side of at least one of the first polarizer and the second polarizer.

9. The display screen of claim 6, wherein, the shielding layer comprises a material of black ink.
